(19) United States
(12) Patent Application Publication
(10) Pub. No.: US 2025/0390348 A1
(43) Pub. Date: Dec. 25, 2025

(54) ADAPTIVE ASYNCHRONOUS COMPUTE

(71) Applicants: Advanced Micro Devices, Inc., Santa Clara, CA (US); ATI Technologies ULC, Markham (CA)

(72) Inventors: PingHang Cheung, Folsom, CA (US); Guennadi Riguer, Thornhill (CA); Randy Ramsey, Oviedo, FL (US); Nishank Pathak, Winter Springs, FL (US); Saurabh Sharma, El Dorado Hills, CA (US)

(21) Appl. No.: 18/753,667

(22) Filed: Jun. 25, 2024

(51) Int. Cl. G06F 9/50

(52) U.S. Cl. CPC G06F 9/5027

(57) ABSTRACT

An apparatus and method for efficient dynamic scheduling of contexts in a processing circuit. In various implementations, a computing system includes a first processing circuit and a second processing circuit that uses multiple single instruction multiple data (SIMD) circuits, each with multiple parallel lanes of execution. When executing the operating system, the first processing circuit divides a workload into multiple contexts and assigns contexts to the second processing circuit. Rather than evenly allocate shared resources of the second processing circuit, the second processing circuit dynamically updates the allocations of shared resources for the multiple contexts based on 10 the dynamic differences of forward progress of the multiple contexts. By performing dynamic allocation updates, the second processing circuit removes the burden of manually updating the allocation and increases throughput of the workload.

### BACKGROUND

### Description of the Relevant Art

The parallelization of tasks is used to increase the throughput of computing systems. To this end, compilers extract parallelized tasks from applications to execute in parallel on the system hardware. To increase parallel execution on the hardware, a parallel data processing circuit includes multiple compute circuits, each with multiple parallel execution lanes, such as single instruction multiple data (SIMD) micro-architectures. These types of micro-architectures provide higher instruction throughput for parallel data applications than a general-purpose micro-architecture. Tasks that benefit from the SIMD micro-architecture are used in a variety of applications in a variety of fields such as medicine, science, chemistry, engineering, social media, finance, and so on.

In various implementations, the host processing circuit executes the operating system that divides the workload of the application into multiple tasks or jobs and assigns the multiple jobs to multiple different work queues associated with different processing circuits. In order to increase throughput and efficient use of the hardware resources of the parallel data processing circuit, the parallel data processing circuit supports executing two or more different jobs concurrently. Each job includes multiple workgroups, each with multiple wavefronts supporting instructions (or commands) of tasks of a different type than a type of tasks of another job. Each job has its own context state.

The parallel data processing circuit supports the concurrent execution of two or more jobs. Therefore, the parallel data processing circuit supports beginning execution of a job while another job is already running without a context switch being performed. As used herein, the “job” can also be referred to as a “context.” An example of the context is a graphics context that includes instructions (or commands) of a video graphics task for executing video pixel rendering. Another example of the context is a compute context that includes instructions (or commands) of a compute task for executing geometry or physics calculations, data transfer operations, video graphics fixed-function post-processing operations, and so forth.

When using the parallel data processing circuit, it is possible to have a non-optimal utilization of shared resources of the hardware resources of the parallel data processing circuit. This non-optimal utilization of shared resources can lead to reduction of efficiency and performance that could lead to an increase in power consumption. Users can attempt manual tuning of the utilization, but the dynamic behavior of the contexts can return the utilization to a non-optimal result. In addition, the users may not fully understand how the shared resources are being used during different stages of execution.

In view of the above, methods and apparatuses for efficient dynamic scheduling of contexts in a processing circuit are desired.

### BRIEF DESCRIPTION OF THE DRAWINGS

FIG. 1 is a generalized diagram of a computing system that performs efficient dynamic scheduling of contexts in a processing circuit.

FIG. 2 is a generalized diagram of an apparatus that performs efficient dynamic scheduling of contexts in a processing circuit.

FIG. 3 is a generalized diagram of a timing diagram that illustrates efficient dynamic scheduling of contexts in a processing circuit.

FIG. 4 is a generalized diagram of a method for efficient dynamic scheduling of contexts in a processing circuit.

FIG. 5 is a generalized diagram of a method for efficient dynamic scheduling of contexts in a processing circuit.

FIG. 6 is a generalized diagram of a method for efficient dynamic scheduling of contexts in a processing circuit.

While the invention is susceptible to various modifications and alternative forms, specific implementations are shown by way of example in the drawings and are herein described in detail. It should be understood, however, that drawings and detailed description thereto are not intended to limit the invention to the particular form disclosed, but on the contrary, the invention is to cover all modifications, equivalents and alternatives falling within the scope of the present invention as defined by the appended claims.

### DETAILED DESCRIPTION

In the following description, numerous specific details are set forth to provide a thorough understanding of the present invention. However, one having ordinary skill in the art should recognize that the invention might be practiced without these specific details. In some instances, well-known circuits, structures, and techniques have not been shown in detail to avoid obscuring the present invention. Further, it will be appreciated that for simplicity and clarity of illustration, elements shown in the figures have not necessarily been drawn to scale. For example, the dimensions of some of the elements are exaggerated relative to other elements.

Apparatuses and methods for efficient dynamic scheduling of contexts in a processing circuit are disclosed. In various implementations, a computing system includes a first processing circuit and a second processing circuit. In an implementation, the first processing circuit is a host processing circuit such as a general-purpose central processing unit (CPU) and the second processing circuit is one of a variety of types of a parallel data processing circuit. When executing an application, the first processing circuit divides the workload of the application into multiple jobs. When executing the operating system, the first processing circuit assigns the jobs to different components of the computing system. The jobs that are assigned to the second processing circuit are referred to as “contexts.” Each context has its own context state. An example of the context is a graphics context that includes instructions (or commands) of a video graphics task for executing video pixel rendering. Another example of the context is a compute context that includes instructions (or commands) of a compute task for executing geometry or physics calculations, data transfer operations, video graphics fixed-function post-processing operations, and so forth. In some implementations, a context corresponds to a kernel (function call) of the application.

Rather than evenly allocate shared resources of the second processing circuit, the second processing circuit dynamically updates the allocations of shared resources for the multiple contexts based on the dynamic differences of forward progress of the multiple contexts. By performing dynamic allocation updates, the second processing circuit removes the burden of manually updating the allocation and increases throughput of the workload. The second processing circuit assigns an initial allocation of shared resources of hardware resources to multiple contexts. The initial allocation can indicate one or more of an assigned number of vector general-purpose registers (VGPRs) per context, an assigned number of scalar general-purpose registers (SGPRs) per context, an assigned access rate or access priority of the VGPRs and the SGPRs, an assigned data storage space per context of one or more of a local data store and shared caches of one or more levels of a cache memory subsystem, an assigned number or rate of wavefronts to dispatch per context, and so on. In some implementations, a single value of allocation is used to generate the assigned numbers, assigned rates, and assigned data storage space of different shared components. For example, a single allocation of 33% for a particular context indicates one third of the assigned numbers, assigned rates, and assigned data storage space of different shared components are allocated to the particular context. In other implementations, a corresponding number of tokens or credits are used to indicate the assigned numbers, assigned rates, and assigned data storage space of different shared components.

The second processing circuit dispatches commands of the multiple contexts concurrently without a context switch being performed. The processing circuit measures differences of forward progress between the multiple contexts. In an implementation, the processing circuit measures the number of instructions completed per clock cycle of the plurality of contexts. In other implementations, the processing circuit measures a number of memory access instructions completed per clock cycle, a number of a particular arithmetic instructions completed per clock cycle, a number of wavefronts dispatched per clock cycle, or other.

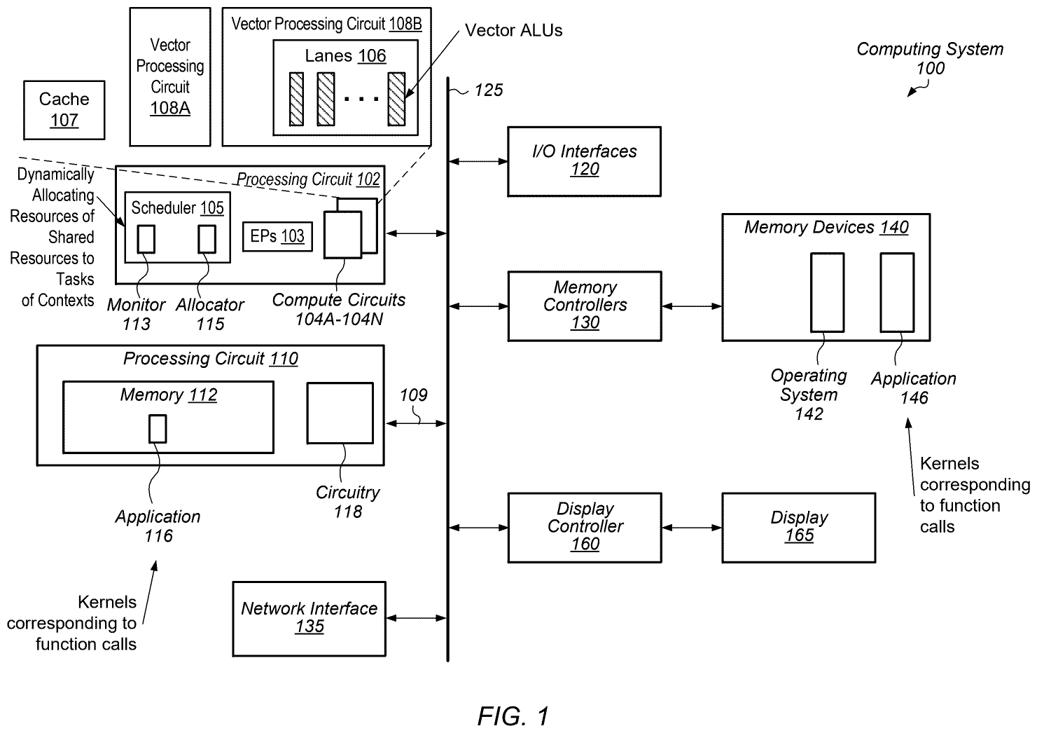

The second processing circuit updates the allocations of the shared resources for the contexts based on differences of forward progress between the contexts. In an implementation, the second processing circuit increases the allocations of shared resources for one or more contexts that have a measure of forward progress less than a measure of forward progress of other contexts and the processing circuit reduces the allocations of shared resources for one or more contexts that have a measure of forward progress greater than a measure of forward progress of other contexts. Further details of these techniques for efficient dynamic scheduling of contexts in a processing circuit are provided in the following description of FIGS. 1-6.

Turning now to FIG. 1, a generalized diagram is shown of a computing system 100 that supports efficient dynamic scheduling of contexts in a processing circuit. In an implementation, computing system 100 includes at least processing circuits 102 and 110, input/output (I/O) interfaces 120, bus 125, network interface 135, memory controllers 130, memory devices 140, display controller 160, and display 165. In other implementations, computing system 100 includes other components and/or computing system 100 is arranged differently. For example, power management circuitry, and phased locked loops (PLLs) or other clock generating circuitry are not shown for ease of illustration. In various implementations, the components of the computing system 100 are on the same die such as a system-on-a-chip (SOC). In other implementations, the components are individual dies in a system-in-package (SiP) or a multi-chip module (MCM). A variety of computing devices use the computing system 100 such as a desktop computer, a laptop computer, a server computer, a tablet computer, a smartphone, a gaming device, a smartwatch, and so on.

Processing circuits 102 and 110 are representative of any number of processing circuits which are included in computing system 100. In an implementation, processing circuit 110 is a general-purpose central processing unit (CPU). In one implementation, processing circuit 102 is a parallel data processing circuit with a highly parallel data microarchitecture, such as a GPU. The processing circuit 102 can be a discrete device, such as a dedicated GPU (dGPU), or the processing circuit 102 can be integrated (an iGPU) in the same package as another processing circuit. Other parallel data processing circuits that can be included in computing system 100 include digital signal processing circuits (DSPs), field programmable gate arrays (FPGAs), application specific integrated circuits (ASICs), and so forth.

In various implementations, processing circuit 102 includes multiple, replicated compute circuits 104A-104N, each including similar circuitry and components such as the vector processing circuits 108A-108B, the cache 107, and other hardware resources (not shown) such as fixed function circuit blocks. Cache 107 can be used as a shared last-level cache. Vector processing circuit 108A includes replicated circuitry of the circuitry of the vector processing circuit 108B. Although two vector processing circuits are shown, in other implementations, another number of vector processing circuits is used based on design requirements. As shown, vector processing circuit 108B includes multiple, parallel computational lanes 106. These parallel computational lanes 106 (or lanes 106) operate in lockstep. In various implementations, the data flow within each of the lanes 106 is pipelined. Pipeline registers are used for storing intermediate results and circuitry for arithmetic logic units (ALUs) perform integer arithmetic, floating-point arithmetic, Boolean logic operations, branch condition comparisons and so forth. These components are not shown for ease of illustration.

A particular combination of the same instruction and a particular data item of multiple data items is referred to as a “work item.” A work item is also referred to as a thread. The multiple work items (or multiple threads) are grouped into thread groups, where a “thread group” is a partition of work executed in an atomic manner. In some implementations, a thread group includes instructions of a function call that operates on multiple data items concurrently. Each data item is processed independently of other data items, but the same sequence of operations of the subroutine is used. As used herein, a “thread group” is also referred to as a “work block” or a “wavefront.”

Tasks performed by lanes 106 can be grouped into a “workgroup” that includes multiple thread groups (or multiple wavefronts). Each of the compute circuits 104A-104N processes an assigned workgroup, and each of the vector processing circuits 108A-108B (or SIMD circuits 108A-108B) processes an assigned wavefront. Scheduler 105 divides the workgroup into separate thread groups (or separate wavefronts) and assigns the wavefronts to be dispatched to vector processing circuits 108A-108B.

Other hardware resources of compute circuits 104A-104N include at least vector general-purpose registers (VGPRs) and scalar general-purpose registers (SGPRs). The high parallelism offered by the hardware of the compute circuits 104A-104N is used for real-time data processing. Examples of real-time data processing are rendering multiple pixels, image blending, pixel shading, vertex shading, and geometry shading. In such cases, each of the data items of a wavefront is a pixel of an image. Compute circuits 104A-104N can also be used to execute other threads that require operating simultaneously with a relatively high number of different data elements (or data items). Examples of these threads are threads for scientific, medical, entertainment, finance and encryption/decryption computations.

In some implementations, the application 146 stored on the memory devices 140 and its copy (application 116) stored on the memory 112 are a highly parallel data application that includes particular function calls using an API to allow the developer to insert a request in the highly parallel data application for launching wavefronts of a kernel (function call). In an implementation, this kernel launch request is a C++ object, and it is converted by circuitry 118 of the processing circuit 110 to a command. Processing circuit 110 stores the commands in a ring buffer in a system memory provided by memory devices 140. A parallel data processing circuit, such as processing circuit 102, reads the commands from the ring buffer. In various implementations, the hardware of scheduler 105 and execution pipelines (or “pipes”) 103 (EPs 103) are included in a command processing circuit (command processor) of processing circuit 102.

A command indicating to launch a kernel is referred to herein as a “kernel.” A kernel mode driver of operating system 142 sends an indication to the command processing circuit of processing circuit 102 to retrieve these kernels. Each of the multiple execution pipes 103 includes multiple work queues, each storing one of multiple assigned kernels from the multiple kernels stored in system memory provided by memory devices 140. Each of the execution pipes 103 can also be referred to as an asynchronous compute engine (ACE) or an asynchronous compute circuit. In an implementation, asynchronous compute circuits process the tasks of a function call (kernel) stored as architected queuing language (AQL) packets in an assigned work queue, and does the processing out of order, when possible, to allow processing circuit 102 to improve utilization of its computing resources.

Asynchronous compute circuits (execution pipes 103) save context state information locally as the asynchronous compute circuits process the tasks of the assigned kernels. In an implementation, processing circuit 102 has eight execution pipes 103, each with eight work queues. Therefore, processing circuit 102 can have 64 separate function calls (kernels) for the vector processing circuits 108A-108B assigned simultaneously and ready for dispatch. Processing circuit 102 can have another number of separate function calls (kernels) for data transfer operations executed by the DMA circuit and another number of separate function calls (kernels) for the fixed-function circuits assigned simultaneously and ready for dispatch. Therefore, processing circuit 102 can support processing more than 64 separate function calls (kernels). These function calls (kernels) belong to one of the categories of jobs such as a video graphics rendering job, a data transfer job, a video graphics post-processing job, a compute job that performs geometry or physics calculations, and so forth. Each of these categories of jobs is a context, and each context has its own context state.

In some implementations, processing circuit 102 includes execution pipes 103 for the vector processing circuits 108A-108B, one or more execution pipes (not shown) for a direct memory access (DMA) circuit (not shown), and one or more execution pipes (not shown) for fixed-function circuits (not shown). The direct memory access (DMA) circuit accesses memory, such as system memory provided by memory devices 140, independent of another processing circuit or core of a processing circuit. In some implementations, the fixed-function circuits include one or more of a video decoder for encoded movies and other videos, a display controller, and so forth. In an implementation, the vector processing circuits 108A-108B are used for real-time data processing, whereas the fixed-function circuits are used for non-real-time data processing. Examples of real-time data processing are rendering multiple pixels, image blending, pixel shading, vertex shading, and geometry shading. Examples of non-real-time data processing are multimedia playback, such as a video decoding for encoded audio/video streams, image scaling, image rotating, color space conversion, and power up initialization. In various implementations, execution pipes 103 operate concurrently with respect to one another and with respect to the execution pipes of the DMA circuit and the fixed-function circuits.

The kernel mode driver sends commands and indications to scheduler 105 of the command processing circuit, which performs kernel mapping operations when new kernels are ready to be executed. When a kernel is assigned to a work queue of one of the execution pipes 103, a mapping operation is performed. In an implementation, the kernel mapping operations (or mapping operations) assign a memory queue descriptor (MQD) of the kernel stored in system memory (a ring buffer in system memory) to a work queue of an execution pipe (one of EPs 103) identified by a hardware queue descriptor (HQD). Other identifiers besides the MQD of the kernel and the HQD of the work queue are possible and contemplated in other implementations to assign (map) the kernel to the work queue.

With the use of execution pipes 103 (and other execution pipes for DMA circuit and fixed-function circuits), less-intensive computing tasks can be processed in an overlapped manner with higher intensive computing tasks (e.g., pixel processing) to fill gaps in execution where the computing resources of processing circuit 102 would otherwise be idle. For example, scheduler 105 can dispatch (or issue) commands of a first task of a first context concurrently with dispatch of commands of a second task of a second context. In an implementation, scheduler 105 can asynchronously dispatch the commands of the second task of the second context with respect to dispatch of commands of the first task of the first context.

In various implementations, scheduler circuit 105 (or scheduler 105) includes a monitor circuit 113 (or monitor 113) and an allocator circuit (or allocator 115). Rather than evenly allocate the resources of shared resources of processing circuit 102, the allocator 115 of scheduler 105 dynamically updates (or dynamically re-allocates) the allocations of resources of the shared resources for the multiple contexts based on the dynamic differences of forward progress of the multiple contexts. By performing dynamic allocation updates, the allocator 115 of scheduler 105 removes the burden of manually updating the allocation and increases throughput of the workload. Allocator 115 assigns an initial allocation of shared resources of hardware resources to the tasks of multiple contexts. The initial allocation can indicate one or more of an assigned number of vector general-purpose registers (VGPRs) per context, an assigned number of scalar general-purpose registers (SGPRs) per context, an assigned access rate or access priority of the VGPRs and the SGPRs, an assigned data storage space per context of one or more of a local data store and shared caches, such as cache 107, of one or more levels of a cache memory subsystem, an assigned number or rate of wavefronts to dispatch per context, an assigned number of compute circuits 104A-104N per context, an assigned number of vector processing circuits 108A-108B per context, and so on. In some implementations, a single value of allocation is used to generate the assigned numbers, assigned rates, and assigned data storage space of different shared components. In other implementations, a vector of multiple bits or multi-bit fields is used to indicate the individual assignments of assigned numbers, assigned rates, and assigned data storage space of different shared components.

Scheduler 105 dispatches commands of the tasks of the multiple contexts concurrently without a context switch being performed. Monitor 113 of scheduler 105 measures differences of forward progress between multiple contexts. In an implementation, monitor 113 measures a number of instructions completed per clock cycle of the tasks of each of the plurality of contexts. In other implementations, monitor 113 measures a number of memory access instructions completed per clock cycle, a number of particular arithmetic instructions completed per clock cycle, a number of wavefronts dispatched per clock cycle, or other. Allocator 115 updates the allocations of the shared resources for the tasks of one or more of the multiple contexts based on differences of forward progress between the multiple contexts measured by monitor 113. In an implementation, allocator 115 increases the allocations of shared resources for one or more contexts that have a measure of forward progress less than a measure of forward progress of other contexts. Allocator 115 reduces the allocations of shared resources for one or more contexts that have a measure of forward progress greater than a measure of forward progress of other contexts. The dynamic allocations assigned to the multiple contexts by scheduler 105 provide higher throughput and more efficient use of hardware resources of processing circuit 102.

Memory 112 represents a local hierarchical cache memory subsystem. Memory 112 stores source data, intermediate results data, results data, and copies of data and instructions stored in memory devices 140. Processing circuit 110 is coupled to bus 125 via interface 109. Processing circuit 110 receives, via interface 109, copies of various data and instructions, such as the operating system 142, one or more device drivers, one or more applications such as application 146, and/or other data and instructions. The processing circuit 110 retrieves a copy of the application 146 from the memory devices 140, and the processing circuit 110 stores this copy as application 116 in memory 112.

In some implementations, computing system 100 utilizes a communication fabric (“fabric”), rather than the bus 125, for transferring requests, responses, and messages between the processing circuits 102 and 110, the I/O interfaces 120, the memory controllers 130, the network interface 135, and the display controller 160. When messages include requests for obtaining targeted data, the circuitry of interfaces within the components of computing system 100 translates target addresses of requested data. In some implementations, the bus 125, or a fabric, includes circuitry for supporting communication, data transmission, network protocols, address formats, interface signals and synchronous/asynchronous clock domain usage for routing data.

Memory controllers 130 are representative of any number and type of memory controllers accessible by processing circuits 102 and 110. While memory controllers 130 are shown as being separate from processing circuits 102 and 110, it should be understood that this merely represents one possible implementation. In other implementations, one of memory controllers 130 is embedded within one or more of processing circuits 102 and 110 or it is located on the same semiconductor die as one or more of processing circuits 102 and 110. Memory controllers 130 are coupled to any number and type of memory devices 140.

Memory devices 140 are representative of any number and type of memory devices. For example, the type of memory in memory devices 140 includes Dynamic Random Access Memory (DRAM), Static Random Access Memory (SRAM), NAND Flash memory, NOR flash memory, Ferroelectric Random Access Memory (FeRAM), or otherwise. Memory devices 140 store at least instructions of an operating system 142, one or more device drivers, and application 146. In some implementations, application 146 is a highly parallel data application such as a video graphics application, a shader application, or other. Copies of these instructions can be stored in a memory or cache device local to processing circuit 110 and/or processing circuit 102.

I/O interfaces 120 are representative of any number and type of I/O interfaces (e.g., peripheral component interconnect (PCI) bus, PCI-Extended (PCI-X), PCIE (PCI Express) bus, gigabit Ethernet (GBE) bus, universal serial bus (USB). Various types of peripheral devices (not shown) are coupled to I/O interfaces 120. Such peripheral devices include (but are not limited to) displays, keyboards, mice, printers, scanners, joysticks or other types of game controllers, media recording devices, external storage devices, and so forth. Network interface 135 receives and sends network messages across a network.

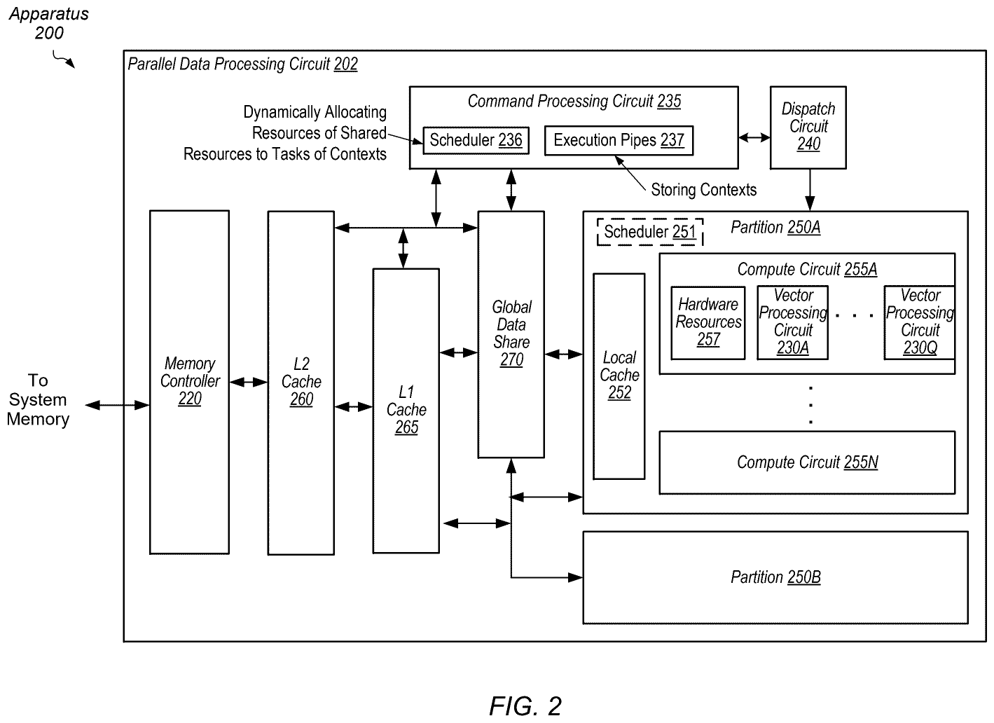

Turning now to FIG. 2, a block diagram is shown of an apparatus 200 that supports efficient dynamic scheduling of contexts in a processing circuit. In one implementation, apparatus 200 includes parallel data processing circuit 202 with an interface to system memory. In an implementation, parallel data processing circuit 202 is a graphics processing unit (GPU). In various implementations, apparatus 200 executes any of various types of highly parallel data applications. As part of executing an application, a host CPU (not shown) launches kernels to be executed by the parallel data processing circuit 202. The command processing circuit 235 receives kernels from the host CPU and determines when dispatch circuit 240 dispatches wavefronts of these kernels to the compute circuits 255A-255N.

Multiple processes of a highly parallel data application provide work to be executed on compute circuits 255A-255N. The parallel data processing circuit 202 includes at least the command processing circuit (or command processor) 235, dispatch circuit 240, compute circuits 255A-255N, memory controller 220, global data share 270, shared level one (L1) cache 265, and level two (L2) cache 260. It should be understood that the components and connections shown for the parallel data processing circuit 202 are merely representative of one type processing circuit and does not preclude the use of other types of processing circuits for implementing the techniques presented herein. The apparatus 200 also includes other components which are not shown to avoid obscuring the figure. In other implementations, the parallel data processing circuit 202 includes other components, omits one or more of the illustrated components, has multiple instances of a component even if only one instance is shown in the apparatus 200, and/or is organized in other suitable manners. Also, each connection shown in apparatus 200 is representative of any number of connections between components. Additionally, other connections can exist between components even if these connections are not explicitly shown in apparatus 200.

In an implementation, the memory controller 220 directly communicates with each of the partitions 250A-250B and includes circuitry for supporting communication protocols and queues for storing requests and responses. Threads within wavefronts executing on compute circuits 255A-255N read data from and write data to the cache 252, vector general-purpose registers, scalar general-purpose registers, and when present, the global data share 270, the shared L1 cache 265, and the L2 cache 260. When present, it is noted that the shared L1 cache 265 can include separate structures for data and instruction caches. It is also noted that global data share 270, shared L1 cache 265, L2 cache 260, memory controller 220, system memory, and cache 252 can collectively be referred to herein as a “cache memory subsystem”.

In various implementations, the circuitry of partition 250B is a replicated instantiation of the circuitry of partition 250A. In some implementations, each of the partitions 250A-250B is a chiplet. As used herein, a “chiplet” is also referred to as an “intellectual property block” (or IP block). However, a “chiplet” is a semiconductor die (or die) fabricated separately from other dies, and then interconnected with these other dies in a single integrated circuit in the MCM. On a single silicon wafer, only multiple chiplets are fabricated as multiple instantiated copies of particular integrated circuitry, rather than fabricated with other functional blocks that do not use an instantiated copy of the particular integrated circuitry. For example, the chiplets are not fabricated on a silicon wafer with various other functional blocks and processors on a larger semiconductor die such as an SoC. A first silicon wafer (or first wafer) is fabricated with multiple instantiated copies of integrated circuitry a first chiplet, and this first wafer is diced using laser cutting techniques to separate the multiple copies of the first chiplet. A second silicon wafer (or second wafer) is fabricated with multiple instantiated copies of integrated circuitry of a second chiplet, and this second wafer is diced using laser cutting techniques to separate the multiple copies of the second chiplet.

In an implementation, cache 252 represents a last level shared cache structure such as a local level-two (L2) cache within partition 250A. Additionally, each of the multiple compute circuits 255A-255N includes vector processing circuits 230A-230Q, each with circuitry of multiple parallel computational lanes of simultaneous execution. These parallel computational lanes operate in lockstep. In various implementations, the data flow within each of the lanes is pipelined. Pipeline registers are used for storing intermediate results and circuitry for arithmetic logic units (ALUs) perform integer arithmetic, floating-point arithmetic, Boolean logic operations, branch condition comparisons and so forth. These components are not shown for ease of illustration. Each of the ALUs within a given row across the lanes includes the same circuitry and functionality, and operates on the same instruction, but different data, such as a different data item, associated with a different thread.

In addition to the vector processing circuits 230A-230Q, compute circuit 255A also includes the hardware resources 257. The hardware resources 257 include at least vector general-purpose registers (VGPRs), scalar general-purpose registers (SGPRs), and assigned data storage space of a local data store. Each of compute circuits 255A-255N receives wavefronts from dispatch circuit 240 and stores the received wavefronts in a corresponding local dispatch circuit (not shown). A local scheduler within compute circuits 255A-255N schedules these wavefronts to be dispatched from the local dispatch circuits to the vector processing circuits 230A-230Q. Cache 252 can be the last level shared cache structure of the partition 250A.

In an implementation, the hardware of scheduler 236 and execution pipes 237 are included in command processing circuit 235. In various implementations, scheduler 236 has the same functionality as scheduler 105 (of FIG. 1) and execution pipes 237 have the same functionality as execution pipes 103 (of FIG. 1). In some implementations, each of partitions 250A-250B includes a scheduler 251 that has the functionality of scheduler 105 (of FIG. 1). Rather than evenly allocate shared resources of parallel data processing circuit 202, control circuitry placed in scheduler 236, scheduler 251, or another location dynamically updates the allocations of shared resources for the multiple contexts based on the dynamic differences of forward progress of tasks of the multiple contexts. By performing dynamic allocation updates, the control circuitry removes the burden of manually updating the allocation and increases throughput of parallel data processing circuit 202 executing the workload that includes the multiple contexts.

The control circuitry of scheduler 236, scheduler 251, or another component measures differences of forward progress between the executing tasks of the multiple contexts stored in execution pipes 237 and dispatched to partitions 250A-250B. In an implementation, the control circuitry measures a number of instructions completed per clock cycle of the plurality of contexts. In other implementations, the control circuitry measures a number of memory access instructions completed per clock cycle, a number of a particular arithmetic instructions completed per clock cycle, a number of wavefronts dispatched per clock cycle, or other. The control circuitry accesses hardware performance counters located throughout parallel data processing circuit 202. The control circuitry measures one or more differences of forward progress between the multiple contexts. If no differences of forward progress exceed a first, then the control circuitry maintains the currently used allocations for the multiple contexts. However, if any differences of forward progress exceed the first threshold, then the control circuitry updates the allocations of the shared resources for the multiple contexts based on the differences of forward progress.

The control circuitry measures one or more differences of allocations between the tasks of multiple contexts. If no differences of allocations exceed a second threshold, then the control circuitry assigns the updated allocations of the shared resources to the multiple contexts. However, if any differences of allocations exceed the second threshold, then the control circuitry updates the allocations of the shared resources to cause differences of allocations to be below the second threshold. Afterward, the control circuitry assigns the updated allocations of the shared resources to the multiple contexts.

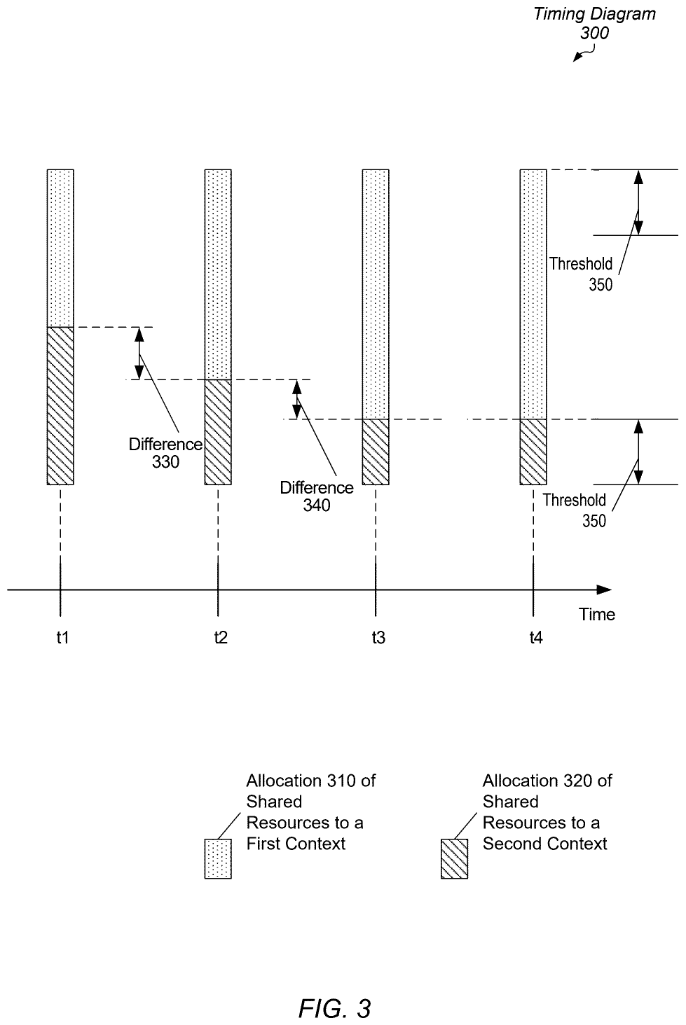

Referring to FIG. 3, a block diagram is shown of a timing diagram 300 that illustrates efficient dynamic scheduling of contexts in a processing circuit. In the illustrated implementation, the allocation 310 of shared resources to a first context and the allocation 320 of shared resources to a second context over time is shown. Although two contexts are described, another number of contexts and corresponding allocations and thresholds can be used based on design requirements. In an implementation, the first context is a graphics context that includes instructions (or commands) of a video graphics task for executing video pixel rendering and the second context is a compute context that includes instructions (or commands) of a compute task for executing geometry or physics calculations, data transfer operations, video graphics fixed-function post-processing operations, and so forth.

At the point-in-time t1 (or time t1), each of the allocation 310 and allocation 320 is initialized. In an implementation, the initial allocation is 50% for each of allocation 310 and allocation 320, although another initial allocation can be used in other implementations. Each of allocation 310 and allocation 320 can indicate one or more of an assigned number of vector general-purpose registers (VGPRs) per context, an assigned number of scalar general-purpose registers (SGPRs) per context, an assigned access rate or access priority of the VGPRs and the SGPRs, an assigned data storage space per context of one or more of a local data store and shared caches of one or more levels of a cache memory subsystem, an assigned number or rate of wavefronts to dispatch per context, and so on. In some implementations, a single value of allocation is used to generate the assigned numbers, assigned rates, and assigned data storage space of different shared components. In other implementations, each of allocation 310 and allocation 320 does not indicate a single value but includes a vector of bits or multi-bit fields that indicate the individual assignments of assigned numbers, assigned rates, and assigned data storage space of different shared components.

Using the initial allocations at time t1, the processing circuit executes the commands of the first context and the second context. The processing circuit monitors forward progress of the first context and the second context. The processing circuit measures differences of forward progress between the multiple contexts. In an implementation, the processing circuit measures a number of instructions completed per clock cycle of the plurality of contexts. In other implementations, the processing circuit measures a number of memory access instructions completed per clock cycle, a number of a particular arithmetic instructions completed per clock cycle, a number of wavefronts dispatched per clock cycle, or other.

At time t2, the processing circuit updates each of allocation 310 and allocation 320 based on the differences of forward progress between the first context and the second context. In an implementation, the second context has a higher measurement of forward progress than the first context. Therefore, the processing circuit increases allocation 310 for the first context and reduces allocation 320 for the second context. The amount of increase (and reduction) is based on the difference in the amount of forward progress between the first context and the second context. The difference 330 indicates the change in allocation 310 and allocation 320 between time t2 and time t1. At time t3 and time t4, the processing circuit repeats these steps. The difference 340 indicates the change in allocation 310 and allocation 320 between time t3 and time t2. At time t4, allocation 320 reaches a threshold 350 (or watermark 350), which is a limit of how much more adjustment can be made to allocation 320. Therefore, no further updates occur for allocation 310 and 320. In some implementations, a similar threshold 350 (or watermark 350) is used for allocation 310. In other implementations, a different threshold different from threshold 350 is used for allocation 310.

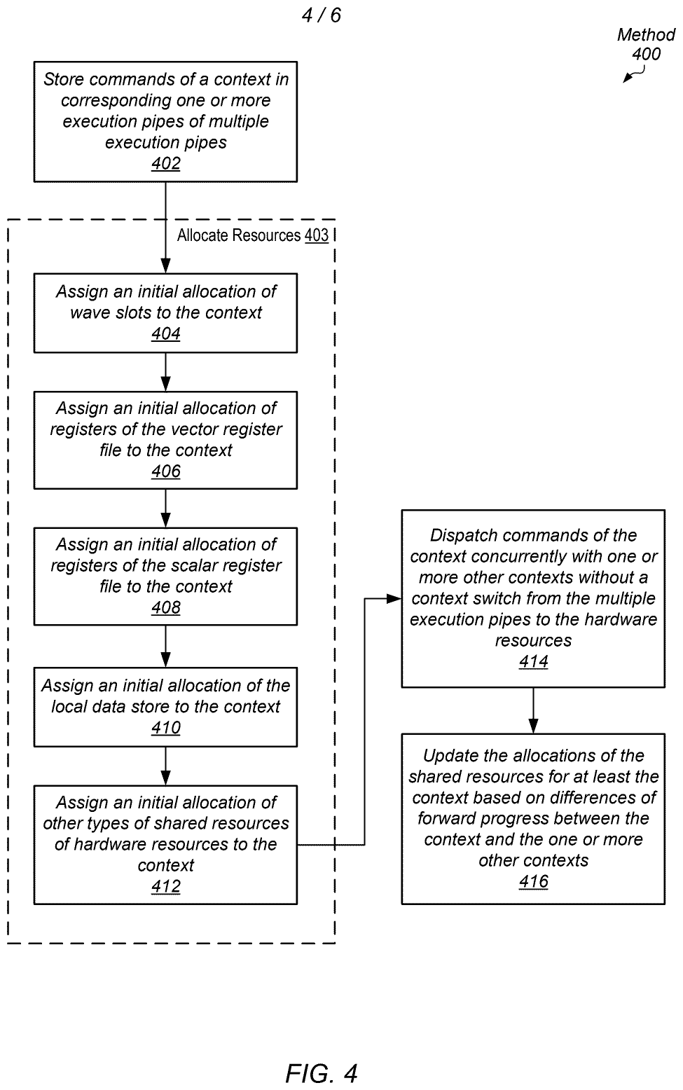

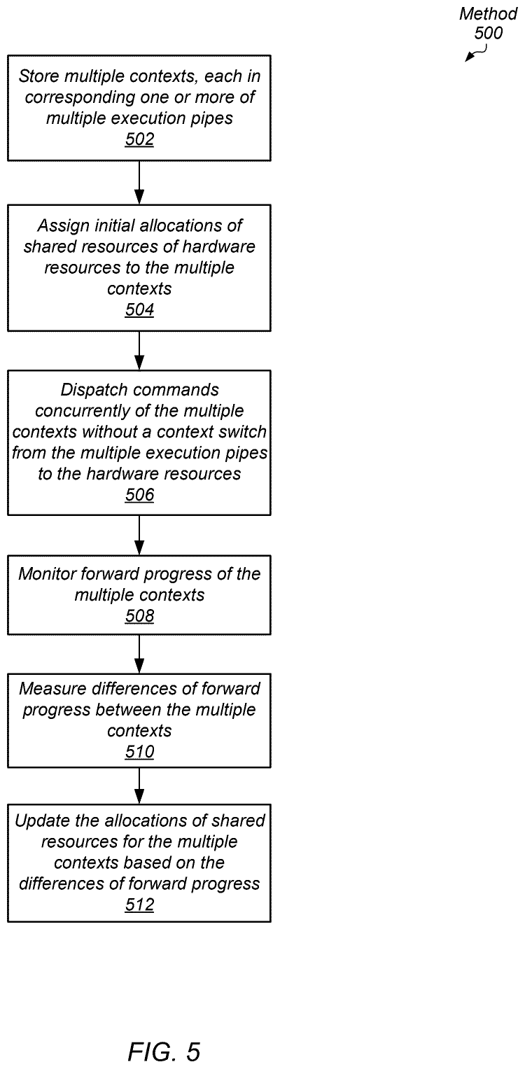

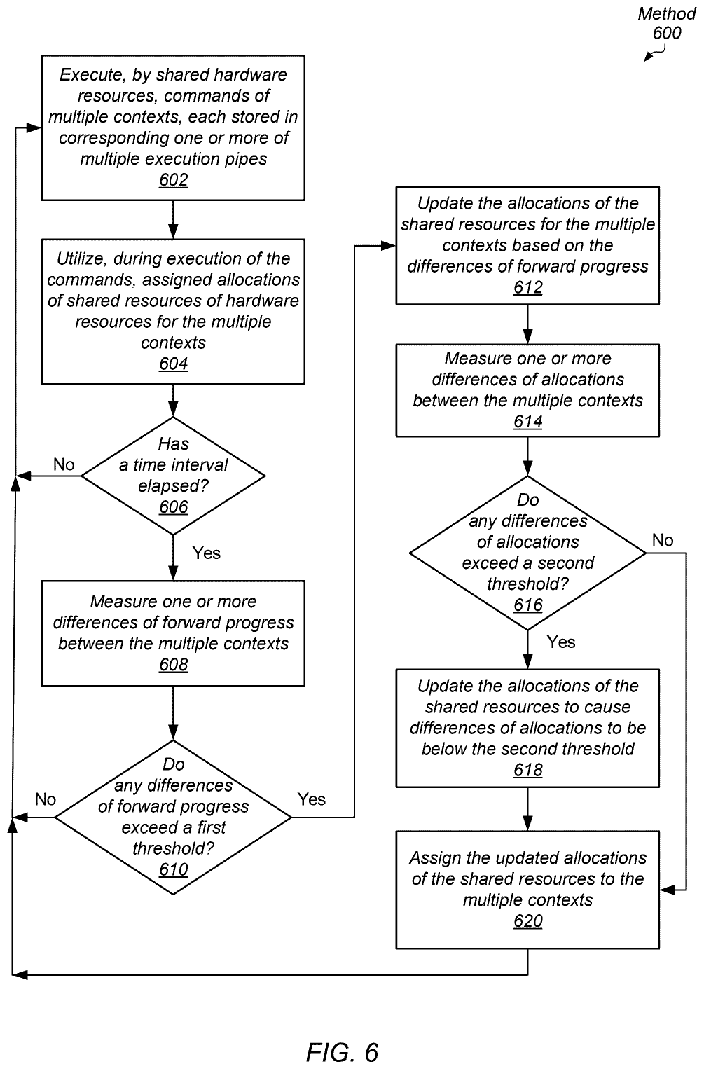

Referring to FIG. 4, a generalized diagram is shown of a method 400 for efficient dynamic scheduling of contexts in a processing circuit. For purposes of discussion, the steps in this implementation (as well as in FIGS. 5-6) are shown in sequential order. However, in other implementations some steps occur in a different order than shown, some steps are performed concurrently, some steps are combined with other steps, and some steps are absent.

A computing system includes a first processing circuit and a second processing circuit. In an implementation, the first processing circuit is a host processing circuit such as a general-purpose central processing unit (CPU) and the second processing circuit is one of a variety of types of a parallel data processing circuit that supports concurrent execution of multiple contexts. In various implementations, the first processing circuit has the same functionality as processing circuit 110 (of FIG. 1) and the second processing circuit has the same functionality as processing circuit 102 (of FIG. 1) and apparatus 200 (of FIG. 2). An application provides a workload for the computing system and the first processing circuit divides the workload into multiple contexts. In an implementation, a first context is a kernel (function call) corresponding to a video graphics pixel rendering workload and a second context is a kernel (function call) corresponding to a compute workload such as a workload for executing geometry or physics calculations, data transfer operations, video graphics fixed-function post-processing operations, and so forth. The second processing circuit stores commands of an assigned context in corresponding one or more execution pipes of multiple execution pipes (block 402).

The second processing circuit allocates resources of one or more shared resources to multiple tasks with each task having a different context (block 403). To do so, the second processing circuit performs the steps of blocks 404-412. For example, in various implementations, the second processing circuit assigns an initial allocation of wave slots to the context (block 404). Each wave slot is assigned to one of the vector processing circuits (or SIMD circuits) of the second processing circuit. The second processing circuit assigns an initial allocation of registers of the vector register file to the context (block 406). The second processing circuit assigns an initial allocation of registers of the scalar register file to the context (block 408). The second processing circuit assigns an initial allocation of the local data store to the context (block 410).

The second processing circuit assigns an initial allocation of other types of shared resources of hardware resources to the context (block 412). In some implementations, a single value of allocation is used to generate the assigned numbers, assigned rates, and assigned data storage space of different shared components. For example, a single allocation of 33% for a particular context indicates one third of the assigned numbers, assigned rates, and assigned data storage space of different shared components are allocated to the particular context. In other implementations, a corresponding number of tokens or credits are used to indicate the assigned numbers, assigned rates, and assigned data storage space of different shared components.

The second processing circuit dispatches commands of the context concurrently with one or more other contexts without a context switch from the multiple execution pipes to the hardware resources (block 414). The second processing circuit updates the allocations of the shared resources for at least the context based on differences of forward progress between the context and the one or more other contexts (block 416). In an implementation, the second processing circuit increases the allocations of shared resources for one or more contexts that have a measure of forward progress less than a measure of forward progress of other contexts and the processing circuit reduces the allocations of shared resources for one or more contexts that have a measure of forward progress greater than a measure of forward progress of other contexts.

Referring to FIG. 5, a generalized diagram is shown of a method 500 for efficient dynamic scheduling of contexts in a processing circuit. A processing circuit stores multiple contexts in multiple execution pipes (block 502). In various implementations, the processing circuit has the same functionality as processing circuit 102 (of FIG. 1) and apparatus 200 (of FIG. 2). The processing circuit stores each of the contexts in one or more execution pipes of the multiple execution pipes. Each context has its own context state. An example of the context is a graphics context that includes instructions (or commands) of a video graphics task for executing video pixel rendering. Another example of the context is a compute context that includes instructions (or commands) of a compute task for executing geometry or physics calculations, data transfer operations, video graphics fixed-function post-processing operations, and so forth. In some implementations, a context corresponds to a kernel (function call) of the application.

The processing circuit assigns initial allocations of shared resources of hardware resources to the multiple contexts (block 504). The initial allocation can indicate one or more of an assigned number of vector general-purpose registers (VGPRs) per context, an assigned number of scalar general-purpose registers (SGPRs) per context, an assigned access rate or access priority of the VGPRs and the SGPRs, an assigned data storage space per context of one or more of a local data store and shared caches of one or more levels of a cache memory subsystem, an assigned number or rate of wavefronts to dispatch per context, and so on. In some implementations, a single value of allocation is used to generate the assigned numbers, assigned rates, and assigned data storage space of different shared components. In other implementations, a number of tokens or credits are used to indicate the assigned numbers, assigned rates, and assigned data storage space of different shared components.

The processing circuit dispatches commands concurrently of the multiple contexts without a context switch from the multiple execution pipes to the hardware resources (block 506). The processing circuit monitors forward progress of the multiple contexts (block 508). In an implementation, the processing circuit measures a number of instructions completed per clock cycle of the plurality of contexts. In other implementations, the processing circuit measures a number of memory access instructions completed per clock cycle, a number of a particular arithmetic instructions completed per clock cycle, a number of wavefronts dispatched per clock cycle, or other. The processing circuit measures differences of forward progress between the multiple contexts (block 510). The processing circuit updates the allocations of shared resources for the multiple contexts based on the differences of forward progress (block 512). In an implementation, the processing circuit increases the allocations of shared resources for one or more contexts that have a measure of forward progress less than a measure of forward progress of other contexts.

Turning now to FIG. 6, a generalized diagram is shown of a method 600 for efficient dynamic scheduling of contexts in a processing circuit. A processing circuit executes, by shared hardware resources, commands of multiple contexts, each stored in corresponding one or more of multiple execution pipes (block 602). In various implementations, the processing circuit has the same functionality as processing circuit 102 (of FIG. 1) and apparatus 200 (of FIG. 2). The processing circuit utilizes, during execution of the commands, assigned allocations of shared resources of hardware resources for the multiple contexts (block 604). The assigned allocations include one or more of an assigned number of vector general-purpose registers (VGPRs) per context, an assigned number of scalar general-purpose registers (SGPRs) per context, an assigned access rate or access priority of the VGPRs and the SGPRs, an assigned data storage space per context of one or more of a local data store and shared caches of one or more levels of a cache memory subsystem, an assigned number or rate of wavefronts to dispatch per context, and so on.

The processing circuit monitors the amount of time that has elapsed and compares it to a time interval. If the time interval has not yet elapsed (“no” branch of the conditional block 606), then control flow of method 600 returns to block 602 where the processing circuit executes, by shared hardware resources, commands of multiple contexts, each stored in corresponding one or more of multiple execution pipes. If the time interval has elapsed (“yes” branch of the conditional block 606), then the processing circuit measures one or more differences of forward progress between the multiple contexts (block 608). In an implementation, the processing circuit measures the number of instructions completed per clock cycle of the plurality of contexts. In other implementations, the processing circuit measures the number of memory access instructions completed per clock cycle, the number of a particular arithmetic instructions completed per clock cycle, the number of wavefronts dispatched per clock cycle, or other.

If no differences of forward progress exceed a first threshold (“no” branch of the conditional block 610), then control flow of method 600 returns to block 602. However, if any differences of forward progress exceed a first threshold (“yes” branch of the conditional block 610), then the processing circuit updates the allocations of the shared resources for the multiple contexts based on the differences of forward progress (block 612). In an implementation, the processing circuit increases the allocations of shared resources for one or more contexts that have a measure of forward progress less than a measure of forward progress of other contexts and the processing circuit reduces the allocations of shared resources for one or more contexts that have a measure of forward progress greater than a measure of forward progress of other contexts. The processing circuit measures one or more differences of allocations between the multiple contexts (block 614).

If no differences of allocations exceed a second threshold (“no” branch of the conditional block 616), then control flow of method 600 moves to block 620 where the processing circuit assigns the updated allocations of the shared resources to the multiple contexts. However, if any differences of allocations exceed a second threshold (“yes” branch of the conditional block 616), then the processing circuit updates the allocations of the shared resources to cause differences of allocations to be below the second threshold (block 618). Afterward, the processing circuit assigns the updated allocations of the shared resources to the multiple contexts (block 620) and control flow of method 600 returns to block 602.

It is noted that one or more of the above-described implementations include software. In such implementations, the program instructions that implement the methods and/or mechanisms are conveyed or stored on a computer readable medium. Numerous types of media which are configured to store program instructions are available and include hard disks, floppy disks, CD-ROM, DVD, flash memory, Programmable ROMs (PROM), random access memory (RAM), and various other forms of volatile or non-volatile storage. Generally speaking, a computer accessible storage medium includes any storage media accessible by a computer during use to provide instructions and/or data to the computer. For example, a computer accessible storage medium includes storage media such as magnetic or optical media, e.g., disk (fixed or removable), tape, CD-ROM, or DVD-ROM, CD-R, CD-RW, DVD-R, DVD-RW, or Blu-Ray. Storage media further includes volatile or non-volatile memory media such as RAM (e.g., synchronous dynamic RAM (SDRAM), double data rate (DDR, DDR2, DDR3, etc.) SDRAM, low-power DDR (LPDDR2, etc.) SDRAM, Rambus DRAM (RDRAM), static RAM (SRAM), etc.), ROM, Flash memory, non-volatile memory (e.g., Flash memory) accessible via a peripheral interface such as the Universal Serial Bus (USB) interface, etc. Storage media includes microelectromechanical systems (MEMS), as well as storage media accessible via a communication medium such as a network and/or a wireless link.

Additionally, in various implementations, program instructions include behavioral-level descriptions or register-transfer level (RTL) descriptions of the hardware functionality in a high-level programming language such as C, or a design language (HDL) such as Verilog, VHDL, or database format such as GDS II stream format (GDSII). In some cases, the description is read by a synthesis tool, which synthesizes the description to produce a netlist including a list of gates from a synthesis library. The netlist includes a set of gates, which also represent the functionality of the hardware including the system. The netlist is then placed and routed to produce a data set describing geometric shapes to be applied to masks. The masks are then used in various semiconductor fabrication steps to produce a semiconductor circuit or circuits corresponding to the system. Alternatively, the instructions on the computer accessible storage medium are the netlist (with or without the synthesis library) or the data set, as desired. Additionally, the instructions are utilized for purposes of emulation by a hardware-based type emulator from such vendors as Cadence®, EVE®, and Mentor Graphics®.

Although the implementations above have been described in considerable detail, numerous variations and modifications will become apparent to those skilled in the art once the above disclosure is fully appreciated. It is intended that the following claims be interpreted to embrace all such variations and modifications.

What is claimed is:

1. An apparatus comprising:
circuitry configured to:
allocate resources of a shared resource to each of a first task and a second task, wherein each of the first task and the second task has a different context;
dispatch concurrently, to the shared resource, commands corresponding to each of the first task and the second task; and
re-allocate resources of the shared resource, responsive to a difference in forward progress between the first task and the second task.

2. The apparatus as recited in claim 1, wherein a context corresponding to the first task is a video graphics context and a context corresponding to the second task is a compute context.

3. The apparatus as recited in claim 1, wherein the shared resource comprises one or more of a plurality of compute circuits of a parallel data processing circuit and a local data store.

4. The apparatus as recited in claim 1, wherein the shared resource comprises one or more of a vector register file and a scalar register file.

5. The apparatus as recited in claim 1, wherein to measure forward progress of the first task and the second task, the circuitry is configured to measure a number of instructions completed per clock cycle.

6. The apparatus as recited in claim 5, wherein the circuitry is configured to allocate more of the shared resource to the first task than the second task, responsive to forward progress of the first task being less than forward progress of the second task.

7. The apparatus as recited in claim 5, wherein the circuitry is configured to allocate no more than a threshold amount of the shared resource to either of the first task or the second task.

8. A method, comprising:
allocating, by a scheduler circuit, resources of a shared resource to each of a first task and a second task, wherein each of the first task and the second task has a different context;
dispatching concurrently, to the shared resource by the scheduler circuit, commands corresponding to each of the first task and the second task; and
re-allocate, by the scheduler circuit, resources of the shared resource, responsive to a difference in forward progress between the first task and the second task.

9. The method as recited in claim 8, wherein a context corresponding to the first task is a video graphics context and a context corresponding to the second task is a compute context.

10. The method as recited in claim 8, wherein the shared resource comprises one or more of a plurality of compute circuits of a parallel data processing circuit and a local data store.

11. The method as recited in claim 8, wherein the shared resource comprises one or more of a vector register file and a scalar register file.

12. The method as recited in claim 8, wherein to measure forward progress of the first task and the second task, the method further comprises measuring a number of instructions completed per clock cycle.

13. The method as recited in claim 12, further comprising allocating more of the shared resource to the first task than the second task, responsive to forward progress of the first task being less than forward progress of the second task.

14. The method as recited in claim 12, further comprising allocating no more than a threshold amount of the shared resource to either of the first task or the second task.

15. A processor comprising:
a shared resource; and
a scheduler circuit configured to:
allocate resources of a shared resource to each of a first task and a second task, wherein each of the first task and the second task has a different context;
dispatch concurrently, to the shared resource, commands corresponding to each of the first task and the second task; and
re-allocate resources of the shared resource, responsive to a difference in forward progress between the first task and the second task.

16. The processor as recited in claim 15, wherein a context corresponding to the first task is a video graphics context and a context corresponding to the second task is a compute context.

17. The processor as recited in claim 15, wherein the shared resource comprises one or more of a plurality of compute circuits of a parallel data processing circuit and a local data store.

18. The processor as recited in claim 15, wherein the shared resource comprises one or more of a vector register file and a scalar register file.

19. The processor as recited in claim 15, wherein to measure forward progress of the first task and the second task, the scheduler circuit is configured to measure a number of instructions completed per clock cycle.

20. The processor as recited in claim 19, wherein the scheduler circuit is configured to allocate more of the shared resource to the first task than the second task, responsive to forward progress of the first task being less than forward progress of the second task.
